(19) United States
(12) Patent Application Publication
(10) Pub. No.: US 2019/0342484 A1
(43) Pub. Date: Nov. 7, 2019

(54) ELECTRONIC DEVICE, CONTROL DEVICE, CONTROL METHOD, AND STORAGE MEDIUM

(71) Applicant: SHARP KABUSHIKI KAISHA, Osaka (JP)

(72) Inventors: KENJI KIMURA, Sakai City (JP); YUSUKE OKUDA, Sakai City (JP); KENICHI OKAMOTO, Sakai City (JP)

(21) Appl. No.: 16/393,459

(22) Filed: Apr. 24, 2019

(30) Foreign Application Priority Data
May 7, 2018 (JP) 2018-089315

(51) Int. Cl. H04N 5/235; H04N 5/232; H04N 5/243; H04N 9/31

(52) U.S. Cl. CPC H04N 5/2354; H04N 5/23218; H04N 9/3182; H04N 5/243; H04N 5/2353

(57) ABSTRACT

An embodiment of the present invention prevents time lag from occurring after a shutter release user operation in the case of image capture in a dark place which involves light emission. A smartphone includes a camera, a smartphone light for illuminating a subject, and a control device. The control device includes: an object detecting section configured to detect an object, the detection being carried out based on an image obtained by the camera, the detection being carried out without a user indicating an object to be detected; a preliminary light emission control section configured to control the smartphone light so as to carry out a preliminary light emission in a case where the object has been detected; and an AF/AE/AWB control section configured to carry out adjustment processing in which at least one of (i) autofocus processing, (ii) autoexposure processing, and (iii) auto white balance adjustment processing is carried out with respect to the object that has been detected, the adjustment processing being carried out based on an image obtained during the preliminary light emission from the smartphone light.

This Nonprovisional application claims priority under 35 U.S.C. § 119 on Patent Application No. 2018-089315 filed in Japan on May 7, 2018, the entire contents of which are hereby incorporated by reference.

### TECHNICAL FIELD

Some aspects of the present invention relate to (i) an electronic device including an image capture device, the image capture device carrying out image capture in a dark place involving use of a flash, (ii) a control device, (iii) a control method, and (iv) a control program.

### BACKGROUND ART

In conventional art, for example, a smartphone including a camera is configured such that, in the case of image capture in a dark place involving use of a flash, a smartphone light is ordinarily illuminated prior to image capture so as to achieve brightness sufficient for an autofocus (AF) operation. Once this brightness is achieved, the autofocus (AF) operation, an autoexposure (AE) operation, and an auto white balance (AWB) operation are carried out. Herein, such a light emission operation is called “preliminary light emission”.

Ordinarily, the preliminary light emission is carried out in the following two cases.
(1) After the user has carried out a shutter release user operation, but before the shutter is released.
(2) After the user has carried out a touch operation to indicate a subject (person or object) to be brought into focus (i.e., after touch autofocusing is carried out).

### CITATION LIST

### Patent Literature

[Patent Literature 1]

Japanese Patent Application Publication, Tokukai, No. 2011-17917

### SUMMARY OF INVENTION

### Technical Problem

Unfortunately, the above-described conventional image capture device has the following problems.

In case (1) described above, after the shutter release user operation, the preliminary light emission, the autofocus (AF) operation, the autoexposure (AE) operation, and the auto white balance (AWB) operation are carried out before the shutter is released. This causes time lag to occur. As a result, the image captured may differ from what the user intended.

In case (2) described above, operations such as the autofocus (AF) operation are carried out in advance, so no time lag occurs after the shutter release user operation. However, since the user is required to carry out an additional step prior to pressing a shutter button, there is an increased likelihood that the user will miss a photo opportunity.

In relation to the above problems, the mobile terminal disclosed in Patent Literature 1, for example, is known prior art for shortening processing time occurring from when a shutter button is pressed to when an image of a subject is obtained.

The mobile terminal disclosed in Patent Literature 1 is configured so as to (i) detect a size of a subject from an image obtained by the camera, (ii) determine, based on the detected size of the subject, the distance to the subject, and (iii) change an image capture mode (e.g., change the luminance of a camera light, change a maximum exposure time, and change a light metering mode) in accordance with the distance determined. This achieves a reduction in the amount of time until when the image of the subject is obtained, as compared to conventional art in which the image capture mode (e.g., the luminance of the camera light, the maximum exposure time, and the light metering mode) is changed after autofocus processing.

Patent Literature 1 does not, however, disclose anything with regard to the mobile terminal in the case of image capture in a dark place which involves use of a flash. As such, in such a case, the mobile terminal of Patent Literature 1 cannot shorten the processing time occurring from when the shutter is pressed to when an image of the subject is obtained.

An aspect of the present invention was made in view of the above problems. An object of the present invention is to provide (i) an electronic device including an image capture device, (ii) a control device, (iii) a control method, and (iv) a control program, each of which makes it possible, in the case of image capture in a dark place which involves light emission, to prevent time lag from occurring after a shutter release user operation.

### Solution to Problem

In order to solve the above problems, an electronic device in accordance with an aspect of the present invention includes: at least one image capture device; at least one lighting device for illuminating a subject; and at least one control device configured to carry out the following: detection processing to detect an object, the detection being carried out based on an image obtained by the at least one image capture device, the detection being carried out without a user indicating an object to be detected; preliminary light emission processing in which, in a case where the object has been detected, the at least one lighting device is controlled so as to carry out a preliminary light emission; and adjustment processing in which at least one of (i) autofocus processing, (ii) autoexposure processing, and (iii) auto white balance adjustment processing is carried out with respect to the object that has been detected, the adjustment processing being carried out based on an image obtained during the preliminary light emission from the at least one lighting device.

In order to solve the above problems, a control device in accordance with an aspect of the present invention is: a control device for controlling at least one image capture device and at least one lighting device for illuminating a subject, the control device including: a detection processing section configured to detect an object, the detection being carried out based on an image obtained by the at least one image capture device, the detection being carried out without a user indicating an object to be detected; a preliminary light emission processing section configured to control the at least one lighting device so as to carry out a preliminary light emission in a case where the object has been detected; and an adjustment processing section configured to carry out adjustment processing in which at least one of (i) autofocus processing, (ii) autoexposure processing, and (iii) auto white balance adjustment processing is carried out with respect to the object that has been detected, the adjustment processing being carried out based on an image obtained during the preliminary light emission from the at least one lighting device.

In order to solve the above problems, a control method in accordance with an aspect of the present invention is: a method of controlling at least one image capture device and at least one lighting device for illuminating a subject, the method including the steps of: detection processing to detect an object, the detection being carried out based on an image obtained by the at least one image capture device, the detection being carried out without a user indicating an object to be detected; preliminary light emission processing in which, in a case where the object has been detected, the at least one lighting device is controlled so as to carry out a preliminary light emission; and adjustment processing in which at least one of (i) autofocus processing, (ii) autoexposure processing, and (iii) auto white balance adjustment processing is carried out with respect to the object that has been detected, the adjustment processing being carried out based on an image obtained during the preliminary light emission from the at least one lighting device.

In order to solve the above problems, a control program in accordance with an aspect of the present invention is: a control program for causing a computer to function as the above-described control device, the control program causing the computer to function as the detection processing section, the preliminary light emission processing section, and the adjustment processing section.

### Advantageous Effects of Invention

Some aspects of the present invention bring about the effect of providing (i) an electronic device including an image capture device, (ii) a control device, (iii) a control method, and (iv) a control program, each of which makes it possible, in the case of image capture in a dark place which involves light emission, to prevent time lag from occurring after a shutter release user operation.

### BRIEF DESCRIPTION OF DRAWINGS

FIG. 1 is a block diagram illustrating a configuration of an electronic device in accordance with Embodiment 1 of the present invention.

FIG. 2 is a flowchart for a method of controlling the electronic device.

(a) to (h) of FIG. 3 each illustrate a screen displayed by the electronic device and an operation carried out, in various steps of control by a control device of the electronic device.

FIG. 4 is a flowchart for an image capture operation which is carried out in a dark place and involves light emission, as carried out by a conventional electronic device.

FIG. 5 is a flowchart for a control operation which is carried out by a conventional electronic device in the case of image capture in a dark place involving light emission, the image capture being carried out after a subject is touched on screen and image capture parameters are set.

### DESCRIPTION OF EMBODIMENTS

[Embodiment 1]

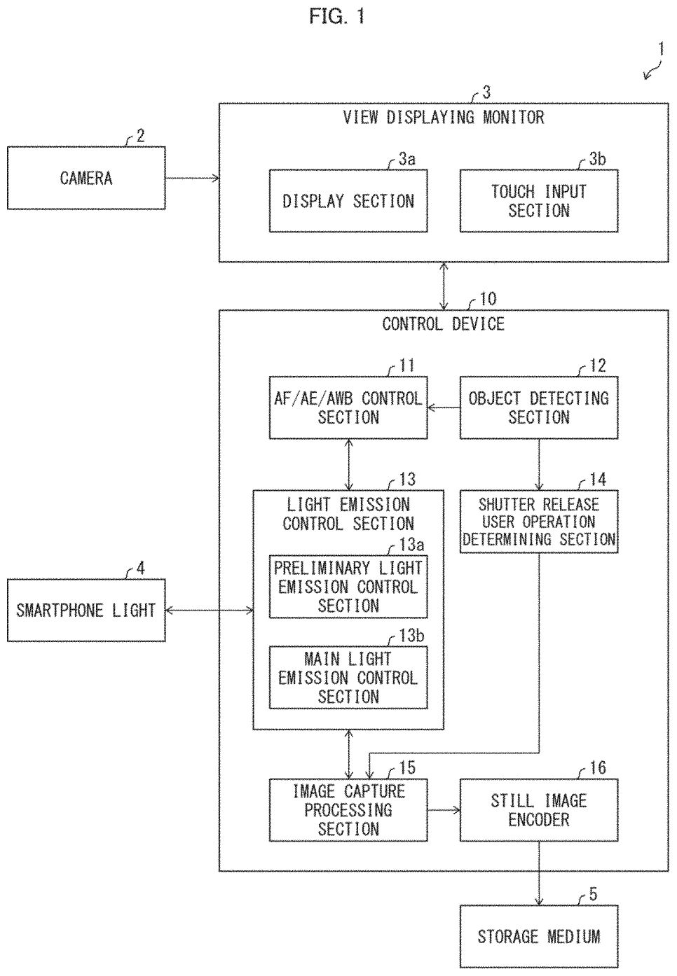

The following description will discuss an embodiment of the present invention with reference to FIGS. 1 to 3.

In Embodiment 1, a smartphone 1 serves as an example of an electronic device. The smartphone 1 is, for example, a mobile information processing terminal which has a camera function. Note however, that the electronic device is not limited to being a mobile information processing terminal. For example, the electronic device may be a digital camera which can be carried by a user. Alternatively, the image capture device may be a security camera which is provided in a fixed manner at a certain location.

With reference to FIG. 1, the following description will discuss a configuration of the smartphone 1 serving as the electronic device in Embodiment 1. FIG. 1 is a block diagram illustrating the configuration the smartphone 1 serving as the electronic device of Embodiment 1.

As illustrated in FIG. 1, the smartphone 1 in accordance with Embodiment 1 includes a camera 2, a view displaying monitor 3, a smartphone light 4, a control device 10, and a storage medium 5.

The camera 2 is, for example, a known camera module. The camera 2 has a known image sensing element. The camera 2 is capable of capturing both still and moving images. Note that the camera 2 may include a plurality of (for example, two) cameras. In such a case, a number of the plurality of cameras (for example, one camera) may be used for capturing still images, and the remaining camera(s) (for example, the other one camera) may be used for capturing moving images. The camera 2 outputs, to the view displaying monitor 3, data of a captured image. The camera 2 also outputs the data of a captured image to the control device 10, either directly or via the view displaying monitor 3.

The view displaying monitor 3 is a member in which a display section 3a and a touch input section 3b are provided in an integral manner. Note, however, that the display section 3a and the touch input section 3b may be provided as members which are separate from each other. For example, a hardware key provided to the smartphone 1 may be used as the touch input section 3b. The touch input section 3b receives various user operations carried out by the user. For example, the user may turn on the camera 2 by pressing a camera app button (icon) which is displayed on the view displaying monitor 3.

The display section 3a serves as an electronic viewfinder. The display section 3a displays, as the view screen, a composition as seen through the lens of the camera 2 (more specifically, the current frame of the moving image being captured in real time by the camera 2). In a certain image capture mode (for example, a manual image capture mode), while viewing the view screen, the user presses a shutter button (a button for indicating to the camera 2 that a shutter release user operation has been carried out) displayed on the view displaying monitor 3. In this way, pressing the shutter button triggers the control device 10 to control the camera 2 to carry out a shutter operation. Note that the shutter operation can also be called a shutter release operation. Similarly, the shutter button can also be called a shutter release button.

The term “shutter operation” refers to an operation in which the camera 2 captures a still image so that the smartphone 1 can obtain the still image. More specifically, the term “shutter operation” refers to a process in which the shutter (electronic shutter) of the camera 2 is released so that the smartphone 1 can obtain a still image. In the shutter operation, image capture parameters are adjusted by carrying out, for example, an autofocus (AF) operation, an autoexposure (AE) operation, and an auto white balance (AWB) operation on the image sensing element of the camera 2. In this way, the user can manually carry out a user operation so as to capture a still image at a desired time and carry out adjustment of image capture parameters. In an aspect of the present invention, carrying out at least one of the autofocus (AF) operation, the autoexposure (AE) operation, and the auto white balance (AWB) operation is sufficient for adjustment of image capture parameter(s).

The control device 10 controls the camera 2 in accordance with a user operation. FIG. 1 illustrates an example in which there is one control device 10 and one storage medium 5 which serves as a storage device. Note, however, that the control device 10 and the storage medium 5 may each be plural in number. The same applies to the camera 2. The same also applies to the view displaying monitor 3 (more specifically, to each of the display section 3a and the touch input section 3b).

The control device 10 carries out overall control of the various sections of the smartphone 1. In particular, the control device 10 controls operations of the camera 2. The storage medium 5 may be, for example, a medium such as flash memory, RAM, an SD card, and/or the like that is removable from the smartphone 1. The storage medium 5 may be a medium such as flash memory, a hard disk drive, and/or the like that is built into the smartphone 1 in advance.

With reference to FIG. 1, the following description will discuss in detail a configuration of the control device 10 of the smartphone 1 in accordance with Embodiment 1.

As illustrated in FIG. 1, the control device 10 of Embodiment 1 includes: an AF/AE/AWB control section 11 serving as an adjustment processing section; an object detecting section 12 serving as a detection processing section; a light emission control section 13; a shutter release user operation determining section 14; an image capture processing section 15; and a still image encoder 16.

The control device 10 of Embodiment 1 is configured so as to operate with use of a chip that differs from a CPU which operates the smartphone 1. This example is non-limiting, however; the CPU which operates the smartphone 1 may be used for operation of the control device 10.

The AF/AE/AWB control section 11 adjusts image capture parameter(s) by carrying out, for example, an autofocus (AF) operation, an autoexposure (AE) operation, and/or an auto white balance (AWB) operation. In particular, in Embodiment 1, in image capture in a dark place which involves illuminating the smartphone light 4, the smartphone light 4 is illuminated, and image capture parameter(s) are adjusted prior to image capture by carrying out, for example, an autofocus (AF) operation, an autoexposure (AE) operation, and/or an auto white balance (AWB) operation.

The object detecting section 12 detects (i) a main subject(s) in an image, (ii) the size of the main subject(s), and (iii) the position of the main subject(s). In particular, in Embodiment 1, the object detecting section 12 carries out processing to detect an object based on an image (frame image from a moving image) obtained from the camera 2, the detection being carried out without the user indicating the object to be detected.

The object detecting section 12 of Embodiment 1 is configured so as to operate with use of a chip that differs from a CPU which operates the control device 10 of Embodiment 1 to operate. Note, however, that the CPU which operates the control device 10 of Embodiment 1 may be used for operation of the object detecting section 12.

In Embodiment 1, the light emission control section 13 includes a preliminary light emission control section 13a and a main light emission control section 13b. In image capture in a dark place involving illumination of the smartphone light 4, the preliminary light emission control section 13a controls the smartphone light 4 to emit light prior to a main light emission; in other words, the preliminary light emission control section 13a controls the smartphone light 4 to carry out a preliminary light emission. The term “preliminary light emission” refers to light emission for the purpose of adjusting image capture parameter(s) via, for example, an autofocus (AF) operation, an autoexposure (AE) operation, and/or an auto white balance (AWB) operation. In other words, the camera 2 is configured such that, in the case of image capture in a dark place involving illumination of the smartphone light 4, as is typically carried out, the smartphone light 4 is illuminated prior to image capture, and, once brightness sufficient for an autofocus (AF) operation is achieved, the autofocus (AF) operation, an autoexposure (AE) operation, and an auto white balance (AWB) operation are carried out. Herein, such a light emission operation is called “preliminary light emission”.

After the preliminary light emission caused by the preliminary light emission control section 13a has finished, the main light emission control section 13b controls the smartphone light 4 to carry out a main light emission for use in actually capturing a still image. The main light emission is what is generally called a flash.

In Embodiment 1, for example, the amount of light emitted by the smartphone light 4 during the main light emission is greater than that emitted during the preliminary light emission caused by the preliminary light emission control section 13a. Thus, during the main light emission, the large amount of light from the smartphone light 4 makes it possible to capture a bright image. Because a lesser amount of light is emitted in the preliminary light emission than in the main light emission, it is possible to decrease the degree of glare experienced, prior to image capture, by the person who is the subject.

Note, however, that it is not necessary for the smartphone light 4 to emit more light during the main light emission than during the preliminary light emission. For example, in one aspect of the present invention, the light emission control section 13 can be configured such that the same amount of light is emitted in both the preliminary light emission and the main light emission. In such a case, the AF/AE/AWB control section 11 is able to carry out an autofocus (AF) operation and an auto white balance (AWB) operation during the preliminary light emission under conditions that are the same as those during the main light emission.

In Embodiment 1, as described later, after the AF/AE/AWB control section 11 carries out adjustment of image capture parameters, the shutter release user operation determining section 14 determines whether or not the user has carried out a shutter release user operation with the image capture parameters thus adjusted. As described earlier, the term “shutter release user operation” refers to a user operation for releasing the shutter (electronic shutter) of the camera 2.

In Embodiment 1, in image capture in a dark place which involves light emission, in a case where the shutter release user operation determining section 14 has determined that the user has carried out a shutter release user operation, the image capture processing section 15 carries out image capture processing to cause the camera 2 to capture a still image.

The still image encoder 16 encodes the still image and causes the storage medium 5 to store the still image thus encoded. The still image encoder 16 of Embodiment 1 is configured so as to operate with use of a chip that differs from the CPU which operates the control device 10 of Embodiment 1. Note, however, that the CPU which operates the control device 10 of Embodiment 1 may be used for operation of the still image encoder 16.

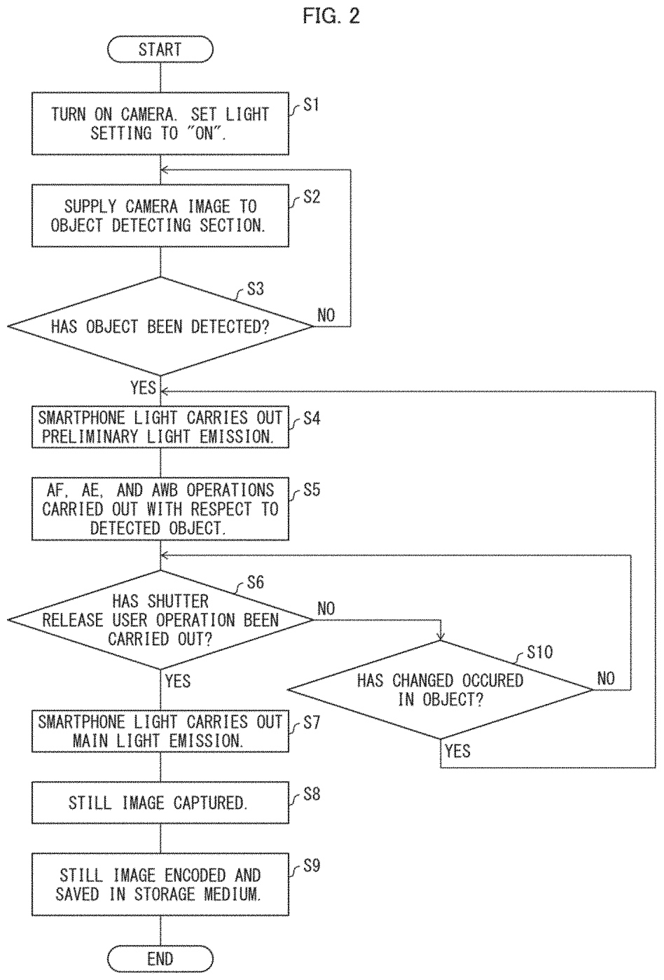

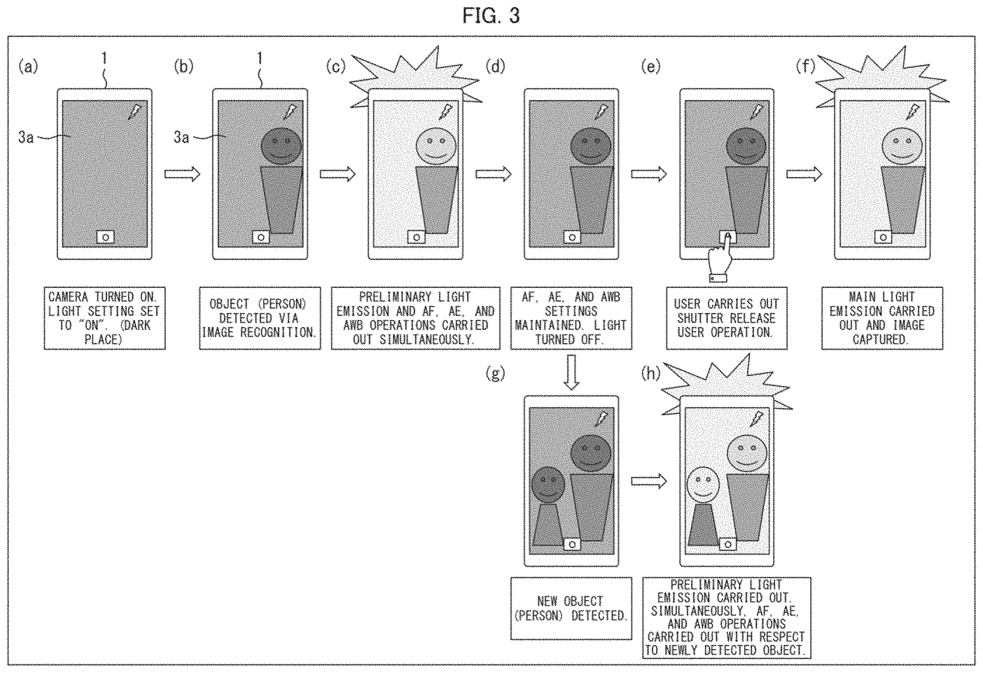

Next, with reference to FIGS. 2 and 3, the following description will discuss image capture processing, as carried out by the smartphone 1 of Embodiment 1 which is configured as described above. FIG. 2 is a flowchart illustrating an operation for image capture in a dark place involving illumination of the smartphone light 4, as carried out by the smartphone 1 of Embodiment 1. (a) to (h) of FIG. 3 each illustrate a screen displayed by the smartphone 1 and an operation carried out, in various steps of control by the control device 10.

As illustrated in FIG. 2, first, the camera 2 is turned on, and a light setting (flash setting) is set to “ON” (S1). Thereafter, a camera image is supplied to the object detecting section 12 (S2), and it is determined whether or not an object has been detected (S3). Specifically, in a case where a camera application of the smartphone 1 is started up in a dark place, a moving image obtained by the camera 2 is displayed on the display section 3a, as illustrated in (a) of FIG. 3. As illustrated in (b) of FIG. 3, in a case where the image includes a detectable object, the object, such as a human, is detected in step S3 via image recognition, and then displayed on the display section 3a. Note that in a case where no object is detected in step S3, the processing returns to step S2.

In a case where it has been determined that the object detecting section 12 has detected an object, the preliminary light emission control section 13a controls the smartphone light 4 to carry out a preliminary light emission (S4). Along with the preliminary light emission by the smartphone light 4, the AF/AE/AWB control section 11 carries out adjustment of image capture parameter(s) by carrying out an autofocus (AF) operation, an autoexposure (AE) operation, and/or an auto white balance (AWB) operation, the adjustment being carried out based on an image obtained during the preliminary light emission (S5). Specifically, as illustrated in (c) of FIG. 3, adjustments such as focusing are made with respect to the object.

In Embodiment 1, in a case where the image capture parameters have been adjusted, thereafter, the smartphone 1 goes into a standby state to await a shutter release user operation. In this standby state, the preliminary light emission of the smartphone light 4 is ceased, as illustrated in (d) of FIG. 3. Note that the image capture parameter settings are maintained.

In the standby state (a state in which the smartphone light 4 has begun emitting less light or ceased emitting light, after the preliminary light emission), it is determined whether or not a shutter release user operation has been carried out, as illustrated in FIG. 2 (S6). This determination is carried out by the shutter release user operation determining section 14. Specifically, the shutter release user operation determining section 14 determines whether or not the user has carried out a shutter release user operation, such as that illustrated in (e) of FIG. 3. In other words, the shutter release user operation determining section 14 determines whether or not the user has pressed the shutter button on the touch input section 3b of the smartphone 1.

In a case where the shutter button is pressed in S6, it is determined that a condition for commencing image capture (“image capture condition”) has been satisfied. Thereafter, the main light emission control section 13b controls the smartphone light 4 to carry out a main light emission (S7), a still image is captured during the main light emission (S8), and the still image is encoded by the still image encoder 16 and then saved in the storage medium 5. Specifically, the still image is captured during the main light emission by the smartphone light 4 as illustrated in (f) of FIG. 3.

Note here that there are cases in which, during standby in step S6, a change occurs in a predetermined image, i.e., an image for which AF and the like was set in step S5. In such a case, it is determined whether or not there has been a change in the target of image capture. Specifically, the object detecting section 12 determines whether or not there has been a change in the object which is the image capture target, since when the image capture parameters were last set (S10). For example, there may occur a change in the position or size of the object which was an image capture target during the preliminary light emission (i.e., the previously detected object). It is also possible that a new object enters the range of image capture. In a case where there has been a change in the object which is an image capture target, since when the image capture parameters were last set, the process returns to step S4, and image capture parameters are adjusted again, by carrying out an autoexposure (AE) operation, an auto white balance (AWB) operation, and/or the like, with use of the preliminary light emission. In a case where, in step S10, there is no change in the object which is an image capture target since when the image capture parameters were last set, the process returns to step S6, and the smartphone 1 awaits a shutter release user operation.

With this configuration, in a case where, for example, the image capture target has changed from being one person to being two persons as illustrated in (g) of FIG. 3, the processing shown in (c) of FIG. 3 is carried out once again, as illustrated in (h) of FIG. 3.

Note that the user may press the shutter button at a desired time. As such, the shutter release user operation can be carried out at any time in the flowchart shown in FIG. 2.

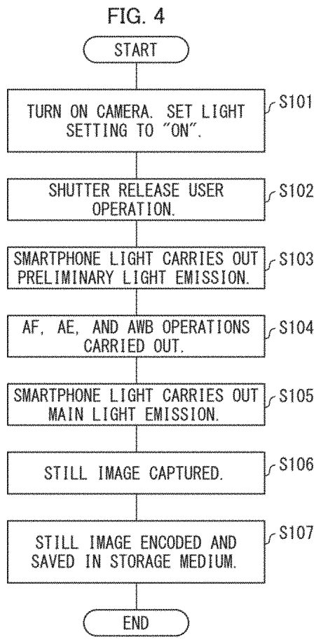

In a case where a shutter release user operation is carried out at a point in time when an autofocus (AF) operation, an autoexposure (AE) operation, an auto white balance (AWB) operation, and the like have not yet been carried out with use of the preliminary light emission (i.e., at a point in time when an object has not been detected and the preliminary light emission has not been carried out), the autofocus (AF) operation, the autoexposure (AE) operation, and the auto white balance (AWB) operation are carried out with use of the preliminary light emission after the shutter release user operation, as is done conventionally, in the manner shown in FIG. 4.

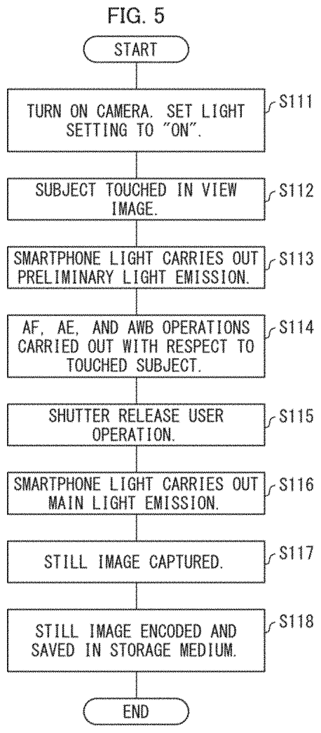

There is a possibility that the user will carry out a touch operation for executing an autofocus (AF) operation during the standby state in step S6, after processing which utilizes the preliminary light emission (such as the autofocus (AF) operation, the autoexposure (AE) operation, and the auto white balance (AWB) operation) has finished. In such a case, with respect to an object indicated by the touch operation as being the image capture target, the autoexposure (AE) operation and the auto white balance (AWB) operation are carried out with use of the preliminary light emission, as is done conventionally, in the manner shown in FIG. 5.

Thus, the smartphone 1 (electronic device) of Embodiment 1 includes: the camera 2, (at least one image capture device); the smartphone light 4 (at least one lighting device) for illuminating a subject; and the control device 10 (at least one control device). The control device is configured to carry out the following: detection processing to detect an object, the detection being carried out based on an image obtained by the camera 2, the detection being carried out without a user indicating an object to be detected; preliminary light emission processing in which, in a case where the object has been detected, the smartphone light 4 is controlled so as to carry out a preliminary light emission; and adjustment processing in which at least one image capture parameter is adjusted by carrying out least one of (i) an autofocus (AF) operation (autofocus processing), (ii) an autoexposure (AE) operation (autoexposure processing), and (iii) an auto white balance (AWB) operation (auto white balance adjustment processing) with respect to the object that has been detected, the adjustment processing being carried out based on an image obtained during the preliminary light emission from the smartphone light 4.

The control device 10 (control device) of Embodiment 1 controls the camera 2 (at least one image capture device) and the smartphone light 4 (at least one lighting device) for illuminating a subject. The control device 10 includes: the object detecting section 12 (detection processing section) configured to detect an object, the detection being carried out based on an image obtained by the camera 2, the detection being carried out without a user indicating an object to be detected; the preliminary light emission control section 13a (preliminary light emission processing section) configured to control the smartphone light 4 so as to carry out a preliminary light emission in a case where the object has been detected; and the AF/AE/AWB control section 11 (adjustment processing section) configured to carry out adjustment processing in which at least one image capture parameter is adjusted by carrying out at least one of (i) an autofocus (AF) operation, (ii) an autoexposure (AE) operation, and (iii) an auto white balance (AWB) operation with respect to the object that has been detected, the adjustment processing being carried out based on an image obtained during the preliminary light emission from the smartphone light 4.

A control method in accordance with Embodiment 1 is a method of controlling the camera 2 (at least one image capture device) and the smartphone light 4 (at least one lighting device) for illuminating a subject, the method including the steps of: detection processing to detect an object, the detection being carried out based on an image obtained by the camera 2, the detection being carried out without a user indicating an object to be detected; preliminary light emission processing in which, in a case where the object has been detected, the smartphone light 4 is controlled so as to carry out a preliminary light emission; and adjustment processing in which at least one image capture parameter is adjusted by carrying out at least one of (i) an autofocus (AF) operation, (ii) an autoexposure (AE) operation, and (iii) an auto white balance (AWB) operation with respect to the object that has been detected, the adjustment processing being carried out based on an image obtained during the preliminary light emission from the smartphone light 4.

With the above configuration, the smartphone 1 includes at least one camera 2, at least one smartphone light 4 for illuminating the subject, and at least one control device 10.

A conventional smartphone is ordinarily configured to operate as follows in the case of image capture in a dark place which involves light emission. First, the user carries out a shutter release user operation at a time that the user has decided is a desirable photo opportunity. The shutter release user operation triggers a preliminary light emission, during which image capture parameters are adjusted by carrying out an autofocus (AF) operation, an autoexposure (AE) operation, and an auto white balance (AWB) operation. Thereafter, a main light emission is carried out, and a still image is captured during the main light emission.

However, with this method, the shutter release user operation triggers the preliminary light emission for adjusting image capture parameters and, thereafter, the main light emission is carried out for image capture. In actual image capture, this method can cause the user to miss a photo opportunity.

The smartphone 1 of Embodiment 1, however, is configured such that when image capture is to be carried out in a dark place, once the camera 2 is turned on, the object detecting section 12 of the control device 10 carries out detection processing to automatically detect an object based on an image obtained from the camera 2, the detection being carried out without the user indicating an object. Thereafter, the preliminary light emission control section 13a of the control device 10 carries out preliminary light emission processing in which, in a case where an object has been detected, the smartphone light 4 is controlled so as to carry out a preliminary light emission. The AF/AE/AWB control section 11 carries out adjustment processing in which an image capture parameter(s) is adjusted by carrying out at least one of (i) an autofocus (AF) operation, (ii) an autoexposure (AE) operation, and (iii) an auto white balance (AWB) operation, the adjustment processing being carried out with respect to the object that has been detected, the adjustment processing being carried out based on an image obtained during the preliminary light emission by the smartphone light 4.

In this way, the smartphone 1 of Embodiment 1 is configured such that once the camera 2 is turned on, an object is detected from an image obtained from the camera 2, without the user indicating an object. Once an object has been detected, preliminary light emission is carried out, and adjustment processing is carried out to adjust image capture parameters. As such, in a case where there is no change in the object thereafter, the main light emission and image capture can be carried out immediately once the user carries out a shutter release user operation (which is an image capture instruction).

This makes it possible to provide (i) the smartphone 1 having the camera 2, (ii) the control device 10, and (iii) a control method, each of which makes it possible, in the case of image capture in a dark place which involves light emission, to prevent time lag from occurring after a shutter release user operation.

The smartphone 1 of Embodiment 1 includes a storage medium 5 (at least one storage device). The smartphone 1 is configured such that, in a case where an image capture condition (condition for commencing image capture) is satisfied, the control device 10 carries out (i) main light emission processing in which the smartphone light 4 is controlled so as to carry out a main light emission, (ii) image capture processing in which the camera 2 is controlled so as to capture a still image during the main light emission, and (iii) save processing in which the still image that has been captured is saved in the storage medium 5.

With this configuration, because the smartphone 1 includes at least one storage medium 5, it is possible to save captured still images in the storage medium 5.

The smartphone 1 of Embodiment 1 is configured such that the control device 10 carries out detection processing again after the adjustment processing. In a case where (i) it is detected that there has been a change in the state of the object or (ii) a new object has been detected, the control device 10 carries out the preliminary light emission processing again and carries out the adjustment processing again, with respect to the object or objects detected.

As such, after the adjustment processing to adjust an image capture parameter has been carried out once, in a case where (i) it is detected that there has been a change in the state of the object or (ii) a new object has been detected, the control device 10 carries out the preliminary light emission processing again and carries out the adjustment processing again, with respect to the object or objects detected. As a result, even in a case where there has been a change in the object after the adjustment processing has been carried out once, the adjustment processing is carried out once again, so that it is possible to prepare for the main light emission.

The smartphone 1 of Embodiment 1 is configured such that in the detection processing, the control device 10 detects an object in an image that was obtained while the smartphone light 4 was not emitting light. With this configuration, because an object is detected based on an image obtained while the smartphone light 4 was not emitting light, it is unnecessary for the smartphone light 4 to emit light for the purpose of object detection.

The smartphone 1 of Embodiment 1 is configured such that the light emission from the smartphone light 4 during the main light emission processing is brighter than the light emission during the preliminary light emission processing. With this configuration, in the preliminary light emission processing, the smartphone light 4 carries out a preliminary light emission, as an assist light, with use of the minimum amount of light necessary for adjustment of an image capture parameter. This makes it possible to extend the life of the power source of the smartphone light 4. In the main light emission processing, the smartphone light 4 emits a large amount of light so that a bright image can be captured. This makes it possible to obtain a clear still image.

The smartphone 1 of Embodiment 1 can be configured such that the light emission from the smartphone light 4 during the preliminary light emission processing and the light emission during the main light emission processing are equal in brightness. With such a configuration, in the preliminary light emission processing, the image capture parameters are adjusted at the same brightness as is used during the main light emission processing. This makes it possible to adjust image capture parameters under the same brightness conditions used in the main light emission processing.

The control device 10 of the smartphone 1 can be configured to carry out the preliminary light emission processing in a manner such that, in a case where an object is detected, the control device 10 controls the smartphone light 4 so as to carry out a preliminary light emission before receiving an image capture instruction from the user (i.e., even without an instruction from the user).

Furthermore, the preliminary light emission control section 13a of the control device 10 can be configured such that, in a case where an object is detected, the preliminary light emission control section 13a carries out processing to control the smartphone light 4 so as to carry out a preliminary light emission, before receiving an image capture instruction from the user.

Furthermore, in a control method in accordance with one embodiment, a preliminary light emission processing step can be carried out such that, in a case where an object is detected, processing is carried out to control the smartphone light 4 so as to carry out a preliminary light emission, before receipt of an image capture instruction from the user.

With such configurations, in a case where (i) the smartphone 1 or the control device 10 is in a state in which the user can carry out a shutter release user operation and (ii) an object is detected, preliminary light emission processing to control the smartphone light 4 to carry out a preliminary light emission can be carried out, before receipt of an image capture instruction in the form of the shutter release user operation.

The smartphone 1 of Embodiment 1 is configured such that the control device 10 determines that the image capture condition (condition for commencing image capture) has been satisfied in a case where an image capture instruction from the user is received in the form of user operation input or voice input into the smartphone 1.

With this configuration, it is possible to determine that the image capture condition is satisfied in a case where the user has provided an image capture instruction.

Furthermore, the image capture instruction from the user can be carried out not only via user operation input into the smartphone 1, but also by voice input from the user.

The smartphone 1 in accordance with an embodiment can be configured such that the control device 10 determines that the image capture condition has been satisfied in a case where movement of the object detected has stopped in an image obtained by the camera 2. Note here that movement of the object in the image can refer to both (i) a case where the object moves while the camera 2 is capturing a moving image in a fixed state and (ii) a case where the camera 2 is being moved while capturing a moving image.

With this configuration, it is possible to determine that the image capture condition (condition for commencing image capture) is satisfied and to subsequently carry out image capture with use of the main light emission in a case where, for example, a moving object stops while the camera 2 is capturing an image in a fixed state. In this way, even without an image capture instruction from the user, in a case where the image capture condition is satisfied, the control device 10 may (i) control the smartphone light 4 to carry out the main light emission and (ii) control the camera 2 to capture a still image.

Furthermore, it is possible to determine that the image capture condition (condition for commencing image capture) is satisfied and to subsequently carry out image capture with use of the main light emission in a case where, for example, the camera 2 itself is being moved during image capture and then the movement of the camera 2 itself stops.

The smartphone 1 of Embodiment 1 can be configured such that, in the adjustment processing, the control device 10 determines at least one image capture parameter, to be used when the camera 2 captures a still image, the at least one image capture parameter including at least one parameter selected from among (i) a focal point position and (ii) an exposure time.

With this configuration, in the adjustment processing, image capture parameters to be used when the camera 2 captures a still image are determined in advance (before the still image is captured). This makes it possible to decrease time lag occurring between the shutter release user operation and the capturing of the still image.

[Embodiment 2]

The following description will discuss another embodiment of the present invention. Aside from the differences described below, Embodiment 2 is configurationally similar to Embodiment 1. For convenience of explanation, the same reference numerals are given to members having functions identical to those described in Embodiment 1, and descriptions of such members are omitted.

Control blocks of a control device 10 in accordance with Embodiment 2 (in particular, an object detecting section 12 serving as a detection processing section, a light emission control section 13 serving as a light emission processing section, and an AF/AE/AWB control section 11 serving as an adjustment processing section) can be realized by a logic circuit (hardware) provided in an integrated circuit (IC chip) or the like or can be alternatively realized by software.

In the latter case, the control device 10 includes a computer that executes instructions of a program that is software realizing the foregoing functions. The computer includes, for example, at least one processor (control device) and at least one storage medium on which the program is stored and from which the program can be read by the computer. An object of an aspect of the present invention can be achieved by the processor of the computer reading and executing the program stored in the storage medium. A central processing unit (CPU), for example, may be used as the processor. Examples of the storage medium encompass a non-transitory tangible medium such as read only memory (ROM), a tape, a disk, a card, a semiconductor memory, and a programmable logic circuit. The computer may further include, for example, random access memory (RAM) in which the program is loaded. Further, the program may be supplied to or made available to the computer via any transmission medium (such as a communication network and a broadcast wave) which enables transmission of the program. Note that an aspect of the present invention can also be achieved in the form of a computer data signal in which the program is embodied via electronic transmission and which is embedded in a carrier wave.

In this way, in Embodiment 2, the control device 10 can be realized in the form of a computer. In such a case, the control device 10 can be realized by the computer by causing the computer to operate as (i) the object detecting section 12 serving as the detection processing section, (ii) the preliminary light emission control section 13a serving as the preliminary light emission processing section, and (iii) the AF/AE/AWB control section 11 serving as the adjustment processing section in the form of software elements. The scope of an aspect of Embodiment 2 also includes a computer-readable storage medium storing a control program (the above-described program).

[Recap]

An electronic device in accordance with Aspect 1 of the present invention includes: at least one image capture device; at least one lighting device for illuminating a subject; and at least one control device configured to carry out the following: detection processing to detect an object, the detection being carried out based on an image obtained by the at least one image capture device, the detection being carried out without a user indicating an object to be detected; preliminary light emission processing in which, in a case where the object has been detected, the at least one lighting device is controlled so as to carry out a preliminary light emission; and adjustment processing in which at least one of (i) autofocus processing, (ii) autoexposure processing, and (iii) auto white balance adjustment processing is carried out with respect to the object that has been detected, the adjustment processing being carried out based on an image obtained during the preliminary light emission from the at least one lighting device.

In Aspect 2 of the present invention, the electronic device can be configured to further include at least one storage device, wherein: the at least one control device is configured to carry out the following in a case where an image capture condition is satisfied after the at least one lighting device has begun emitting less light or ceased emitting light: main light emission processing in which the at least one lighting device is controlled so as to carry out a main light emission; image capture processing in which the at least one image capture device is controlled so as to capture a still image during the main light emission; and save processing in which the still image that has been captured is saved in the at least one storage device.

In Aspect 3 of the present invention, the electronic device can be configured such that the at least one control device is configured to: carry out the detection processing again after the adjustment processing; and in a case where (i) it is detected that there has been a change in a state of the object or (ii) a new object has been detected, carry out the preliminary light emission processing again and carry out the adjustment processing again, with respect to the object or objects detected.

In Aspect 4 of the present invention, the electronic device can be configured such that in the detection processing, the at least one control device detects the object in an image that was obtained while the at least one lighting device was not emitting light.

In Aspect 5 of the present invention, the electronic device can be configured such that the main light emission is brighter than the preliminary light emission.

In Aspect 6 of the present invention, the electronic device can be configured such that the preliminary light emission and the main light emission are equal in brightness.

In Aspect 7 of the present invention, the electronic device can be configured such that in a case where an image capture instruction from the user is received prior to the object being detected, the at least one control device carries out the preliminary light emission processing and the adjustment processing.

In Aspect 8 of the present invention, the electronic device can be configured such that the at least one control device determines that the image capture condition has been satisfied in a case where an image capture instruction from the user is received in the form of user operation input or voice input into the electronic device.

In Aspect 9 of the present invention, the electronic device can be configured such that the at least one control device determines that the image capture condition has been satisfied in a case where movement of the object detected has stopped in an image obtained by the at least one image capture device. Note here that movement of the object in the image can refer to both (i) a case where the object moves while the at least one image capture device is capturing an image in a fixed state and (ii) a case where the at least one image capture device is being moved while capturing an image.

In Aspect 10 of the present invention, the electronic device can be configured such that in the adjustment processing, the at least one control device determines at least one image capture parameter, to be used when the at least one image capture device captures a still image, the at least one image capture parameter including at least one parameter selected from among (i) a focal point position and (ii) an exposure time.

A control device in accordance with Aspect 11 of the present invention is a control device for controlling at least one image capture device and at least one lighting device for illuminating a subject, the control device including: a detection processing section configured to detect an object, the detection being carried out based on an image obtained by the at least one image capture device, the detection being carried out without a user indicating an object to be detected; a preliminary light emission processing section configured to control the at least one lighting device so as to carry out a preliminary light emission in a case where the object has been detected; and an adjustment processing section configured to carry out adjustment processing in which at least one of (i) autofocus processing, (ii) autoexposure processing, and (iii) auto white balance adjustment processing is carried out with respect to the object that has been detected, the adjustment processing being carried out based on an image obtained during the preliminary light emission from the at least one lighting device.

A control method in accordance with Aspect 12 of the present invention is a method of controlling at least one image capture device and at least one lighting device for illuminating a subject, the method including the steps of: detection processing to detect an object, the detection being carried out based on an image obtained by the at least one image capture device, the detection being carried out without a user indicating an object to be detected; preliminary light emission processing in which, in a case where the object has been detected, the at least one lighting device is controlled so as to carry out a preliminary light emission; and adjustment processing in which at least one of (i) autofocus processing, (ii) autoexposure processing, and (iii) auto white balance adjustment processing is carried out with respect to the object that has been detected, the adjustment processing being carried out based on an image obtained during the preliminary light emission from the at least one lighting device.

A control program in accordance with Aspect 13 of the present invention is a control program for causing a computer to function as the above-described control device, the control program causing the computer to function as the detection processing section, the preliminary light emission processing section, and the adjustment processing section.

The present invention is not limited to the foregoing embodiments, but can be altered by a skilled person in the art within the scope of the claims. The present invention also encompasses, in its technical scope, any embodiment derived by combining technical means disclosed in differing embodiments. It is possible to form a new technical feature by combining the technical means disclosed in the respective embodiments.

### Reference Signs List

1 Smartphone (electronic device)

2 Camera (image capture device)

3 View displaying monitor

3a Display section

3b Touch input section

4 Smartphone light (lighting device)

5 Storage medium (storage device)

10 Control device

11 AF/AE/AWB control section (adjustment processing section)

12 Object detecting section (detection processing section)

13 Light emission control section

13a Preliminary light emission control section (preliminary light emission processing section)

13b Main light emission control section

14 Shutter release user operation determining section

15 Image capture processing section

16 Still image encoder

1. An electronic device comprising:
at least one image capture device;
at least one lighting device for illuminating a subject; and
at least one control device configured to carry out the following:
detection processing to detect an object, the detection being carried out based on an image obtained by the at least one image capture device, the detection being carried out without a user indicating an object to be detected;
preliminary light emission processing in which, in a case where the object has been detected, the at least one lighting device is controlled so as to carry out a preliminary light emission; and
adjustment processing in which at least one of (i) autofocus processing, (ii) autoexposure processing, and (iii) auto white balance adjustment processing is carried out with respect to the object that has been detected, the adjustment processing being carried out based on an image obtained during the preliminary light emission from the at least one lighting device.

2. The electronic device according to claim 1, further comprising at least one storage device, wherein:
the at least one control device is configured to carry out the following in a case where an image capture condition is satisfied after the at least one lighting device has begun emitting less light or ceased emitting light:
main light emission processing in which the at least one lighting device is controlled so as to carry out a main light emission;
image capture processing in which the at least one image capture device is controlled so as to capture a still image during the main light emission; and
save processing in which the still image that has been captured is saved in the at least one storage device.

3. The electronic device according to claim 1, wherein the at least one control device is configured to:
carry out the detection processing again after the adjustment processing; and
in a case where (i) it is detected that there has been a change in a state of the object or (ii) a new object has been detected, carry out the preliminary light emission processing again and carry out the adjustment processing again, with respect to the object or objects detected.

4. The electronic device according to claim 1, wherein in the detection processing, the at least one control device detects the object in an image that was obtained while the at least one lighting device was not emitting light.

5. The electronic device according to claim 2, wherein the main light emission is brighter than the preliminary light emission.

6. The electronic device according to claim 2, wherein the preliminary light emission and the main light emission are equal in brightness.

7. The electronic device according to claim 1, wherein in a case where an image capture instruction from the user is received prior to the object being detected, the at least one control device carries out the preliminary light emission processing and the adjustment processing.

8. The electronic device according to claim 2, wherein the at least one control device determines that the image capture condition has been satisfied in a case where an image capture instruction from the user is received in the form of user operation input or voice input into the electronic device.

9. The electronic device according to claim 2, wherein the at least one control device determines that the image capture condition has been satisfied in a case where movement of the object detected has stopped in an image obtained by the at least one image capture device.

10. The electronic device according to claim 1, wherein in the adjustment processing, the at least one control device determines at least one image capture parameter, to be used when the at least one image capture device captures a still image,
the at least one image capture parameter including at least one parameter selected from among (i) a focal point position and (ii) an exposure time.

11. A control device for controlling at least one image capture device and at least one lighting device for illuminating a subject, the control device comprising:
a detection processing section configured to detect an object, the detection being carried out based on an image obtained by the at least one image capture device, the detection being carried out without a user indicating an object to be detected;
a preliminary light emission processing section configured to control the at least one lighting device so as to carry out a preliminary light emission in a case where the object has been detected; and
an adjustment processing section configured to carry out adjustment processing in which at least one of (i) autofocus processing, (ii) autoexposure processing, and (iii) auto white balance adjustment processing is carried out with respect to the object that has been detected, the adjustment processing being carried out based on an image obtained during the preliminary light emission from the at least one lighting device.

12. A method of controlling at least one image capture device and at least one lighting device for illuminating a subject, the method comprising the steps of:
detection processing to detect an object, the detection being carried out based on an image obtained by the at least one image capture device, the detection being carried out without a user indicating an object to be detected;
preliminary light emission processing in which, in a case where the object has been detected, the at least one lighting device is controlled so as to carry out a preliminary light emission; and
adjustment processing in which at least one of (i) autofocus processing, (ii) autoexposure processing, and (iii) auto white balance adjustment processing is carried out with respect to the object that has been detected, the adjustment processing being carried out based on an image obtained during the preliminary light emission from the at least one lighting device.

13. A computer-readable non-transitory storage medium storing a control program for causing a computer to function as the control device recited in claim 11,
the control program causing the computer to function as the detection processing section, the preliminary light emission processing section, and the adjustment processing section.
